(19) United States
(12) Patent Application Publication
(10) Pub. No.: US 2013/0006738 A1
(43) Pub. Date: Jan. 3, 2013

(54) SHARED ELECTRONIC INCENTIVES AND COUPONS LEVERAGING SOCIAL CONNECTIONS AND SHEPHERDING

(75) Inventors: Eric Horvitz, Kirkland, WA (US); Roger Barga, Bellevue, WA (US); Lili Cheng, Bellevue, WA (US); Doug Burger, Bellevue, WA (US); Vinay Gupta, Sammamish, WA (US); Xuedong Huang, Bellevue, WA (US); Zachary Apter, Seattle, WA (US)

(73) Assignee: MICROSOFT CORPORATION, Redmond, WA (US)

(21) Appl. No.: 13/174,255

(22) Filed: Jun. 30, 2011

(51) Int. Cl. G06Q 30/00

(52) U.S. Cl. 705/14.16; 705/14.39; 705/14.25

(57) ABSTRACT

Systems and methods for distributing shared electronic coupons are provided. According to one aspect, the electronic coupon may include a coupon benefit display region displaying a textual and/or graphical representation of a coupon benefit. The electronic coupon may further include a candidate display region displaying a list of one or more friends of the user who are determined to be redeemer candidates from among friends in a social network profile or address book of the user. Each redeemer candidate friend in the list has an associated selector, and selection by the user of a selector corresponding to a friend causes the client device to send a message to a coupon server to instruct the coupon server to send the electronic coupon to a client device of the selected friend. Predictive models generated through machine learning may aid in selecting the user to which coupons are distributed and the redeemer candidates.

### BACKGROUND

Electronic coupons delivered to a user by email or a web browser, for example, provide advertisers a way to incentivize users to purchase certain goods and services, without the printing costs and shipping delays of traditional paper coupons. Recently, group-oriented electronic coupon systems have been developed. In these systems, users register to receive daily electronic coupons from local businesses. The electronic coupons may be shared by users through email and social networks, for example. Users visit the coupon website, and indicate their willingness to purchase the goods or services at the deal price offered in the coupon, for example. The coupons are redeemable only if a minimum number of users indicate their willingness to purchase. In this way, the users are encouraged to socially promote the coupon by distributing it to their social network friends and email contacts. Further, because the advertiser does not have to offer the deal price unless the minimum transaction volume is met, the advertiser has reduced risk of poor coupon performance, and can more appropriately tailor the discount price to expected sales volumes.

While these group-oriented electronic coupon systems attempt to leverage the social influence of receiving a special offer from a friend, they suffer from the drawback that users may be self-motivated to share deals on products whether or not they believe that their friends will be interested. Users may begin to ignore the coupons as the number of coupons increases and the relevance of each coupon to the user decreases. Further, in many cases the minimum number of interested purchasers may not be met, and as a result the offered deal will be retracted, leaving many users disappointed.

### SUMMARY

To address the above issues, systems and methods for distributing shared electronic coupons are provided. According to one aspect, the electronic coupon may include a coupon benefit display region displaying a textual and/or graphical representation of a coupon benefit. The electronic coupon may further include a candidate display region displaying a list of one or more friends of the user who are determined to be redeemer candidates from among friends in a social network profile or address book of the user. Each redeemer candidate friend in the list has an associated selector, and selection by the user of a selector corresponding to a friend causes the client device to send a message to a coupon server to instruct the coupon server to send the electronic coupon to a client device of the selected friend.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an electronic coupon served by a coupon server system and displayed on each of a user client device and a friend client device, according to one embodiment.

FIG. 2 is a partial schematic view of the coupon server system of FIG. 1, illustrating communication of a sharable electronic coupon first to a user, then to a friend, and then to a friend of a friend.

FIG. 3 is a detailed schematic view of hardware and software components of the coupon server system of FIG. 1.

FIG. 4 is a communications flow diagram illustrating one embodiment of a method for distributing electronic coupons among client devices.

### DETAILED DESCRIPTION

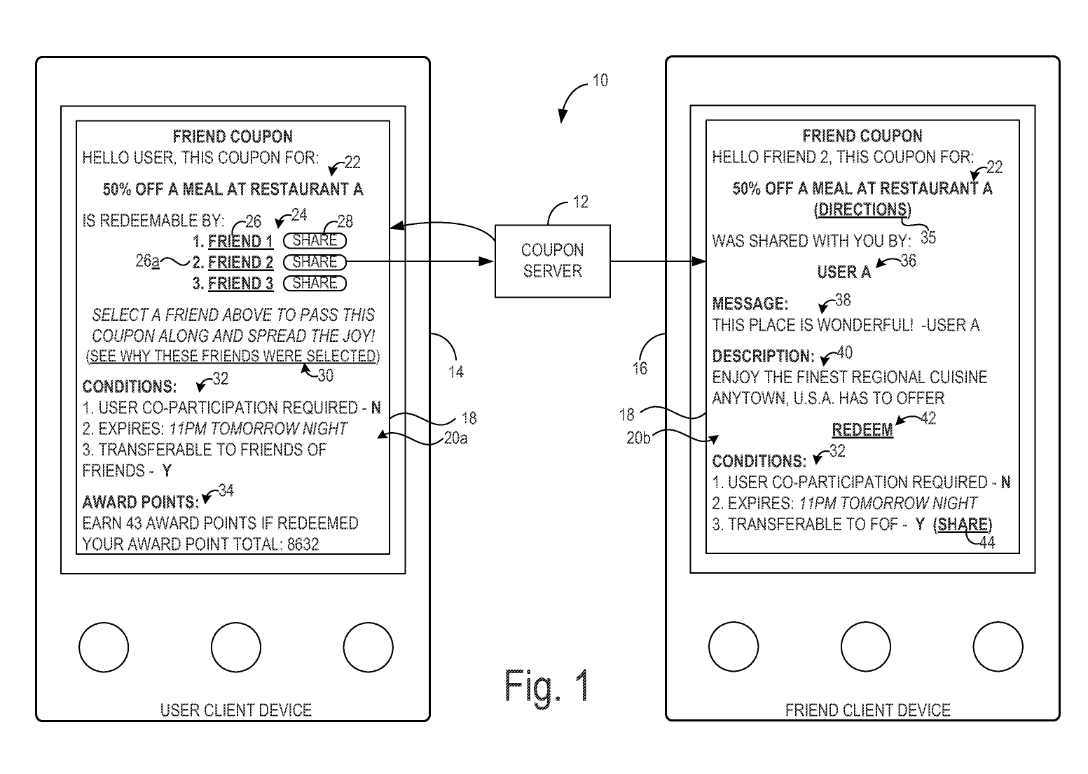

To address the above discussed issues, systems and methods for distributing shared electronic coupons are provided. FIG. 1 illustrates generally a computerized coupon server system 10 including a coupon server 12 configured to communicate via computer networks such as the Internet with a plurality of client devices, including a user client device 14 and a friend client device 16. The coupon server 12 is configured to serve a user view 20a of an electronic coupon 18 to the user client device 14. The coupon is typically redeemable by a friend of the user, or by the user and a friend together, but is not redeemable by the user alone. Thus, the user is prompted to share the electronic coupon with one or more friends to enable the friends to enjoy the benefit of the coupon, as described below.

The user view 20a of the electronic coupon 18 may include a benefit display region 22 displaying a textual and/or graphical representation of a coupon benefit. The benefit may be a discount on a target product or service, for example. In the depicted embodiment, a 20% discount at Restaurant A is displayed as the benefit. It will be appreciated that a wide variety of other benefits may be presented, including a free product or service, free shipping on an order for a product, preferred seating, preferred order status for high demand products, etc.

The user view 20a of the electronic coupon 18 may further include a candidate display region 24 displaying a list of one or more redeemer candidate friends 26 for the coupon. The redeemer candidate friends 26 are identified by the coupon server 12 from among friends in a social network profile or address book of the user, for example, as individuals who would be potentially amenable to the electronic coupon, based on various redeemer candidate factors, as discussed below. The user may select a selector 30 to view an explanation of the redeemer candidate factors to understand why the listed redeemer candidate friends were selected. Each redeemer candidate friend 26 in the list has an associated selector 28, and selection by the user of a selector 28 corresponding to a particular redeemer candidate friend causes the client device to send a message to the coupon server 12 to instruct the coupon server 12 to send the electronic coupon 18 to the friend client, device 16 of the selected redeemer candidate friend 26a. In response, the coupon server 12 serves a friend view 20b of the electronic coupon 18 to the friend client device 16 of the selected redeemer candidate friend 26a.

Returning briefly to the user view 20a of the electronic coupon 18, this view includes a conditions display region 32 including one or more conditions of the coupon benefit. The conditions may specify that the benefit is redeemable by the friend, or by the user and the friend together, but not by the user. In FIG. 1, this is accomplished by specifying whether user co-participation is required for redemption of the coupon benefit (No in FIG. 1). The conditions further specify when the coupon expires (11 pm tomorrow in FIG. 1), and whether the coupon is transferable to (and thus redeemable by), for example, friends of friends in the user's social network (Yes in FIG. 1).

The user view 20a of the electronic coupon 18 may further include an award points display region 34 including a display of award points earned by the user through sharing electronic coupons with social network friends who redeem those coupons. The award points earned upon a friend redeeming the current electronic coupon 18 may be displayed, as may the total award points earned by the user since the user became a registered user of the coupon server 12. The award points may be redeemable for products and services, or cash back, as desired. In some cases, the award points may be combined with the coupon benefit, and either passed to the selected redeemer candidate friend to redeem, or enjoyed together as the user co-participates with the selected redeemer candidate friend in the redemption of the electronic coupon.

Turning now to friend view 20b of the electronic coupon 20 displayed on the friend client device 16 of the selected redeemer candidate friend 26a, this view typically includes the coupon benefit display region 22, and a directions link 35 to obtain a map and directions to the establishment at which the electronic coupon 18 may be redeemed. The friend view 20b may further include an identity of the user 36 from which the selected redeemer candidate 26a received the coupon, and a message 38 from the user for display to the selected redeemer candidate friend 26a. The message 38 may, for example, be input by the user in a pop-up window or other suitable text-receiving interface of the user view 20a.

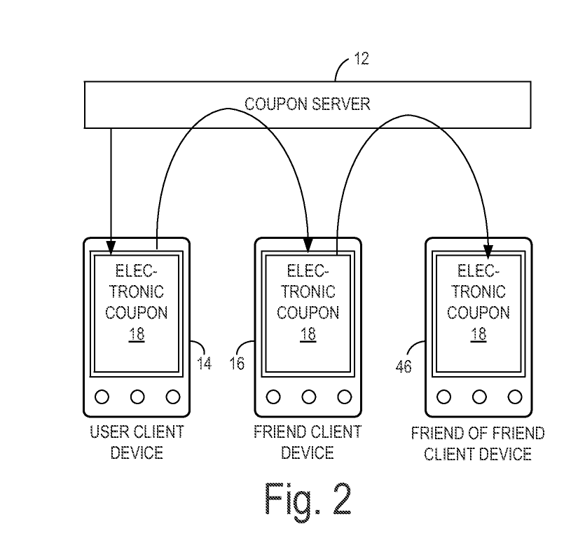

The friend view 20b may also include a redemption selector 42, which upon actuation is configured to initiate redemption of the electronic coupon, for example, with the coupon server 12 or a server of the advertiser, for example. The friend view 20b may also include a conditions display region 32, including similar information regarding user co-participation, expiration, and transferability, as the conditions display region 32 of the user view 20a. A share selector 44 may be provided by which the friend may transfer the electronic coupon to a friend (i.e., a friend of a friend of the user), in the manner illustrated in FIG. 2.

Turning now to FIG. 2, as discussed above, the coupon server 12 of the computerized coupon server system 10 may be used to distribute an electronic coupon 18 first to a user device 14, and then, upon selection of a redeemer candidate friend, to a friend client device 16. Upon selection of share selector 44 discussed above in relation to FIG. 1, the redeemer candidate friend may cause the friend client device 16 to send a message to the coupon server 12 to forward the electronic coupon to a friend of the redeemer candidate friend. This causes the coupon server 12 to send the electronic coupon to a friend of a friend client device 46. In this manner, users may share coupons with friends, which may in turn share the same coupons with their friends, and so on, thereby promulgating the message of the electronic coupon 18 to a wide audience.

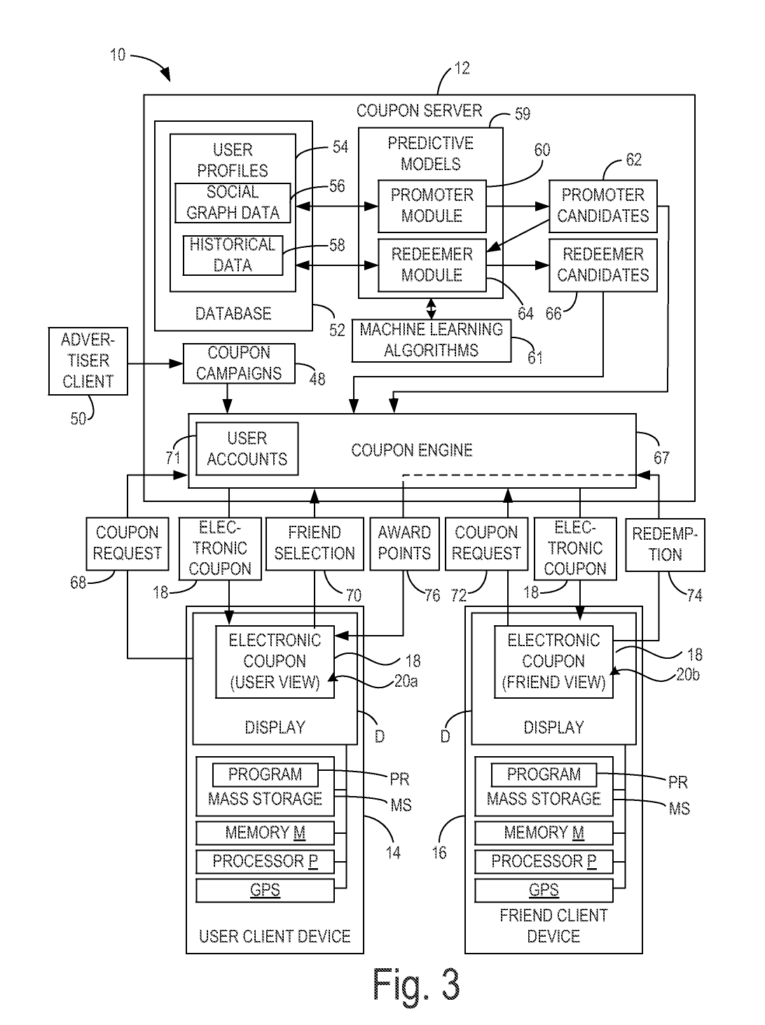

Turning now to FIG. 3, detailed software and hardware components of the computerized coupon server system 10 will now be described. The computerized coupon server system 10 may include at least one server device configured as a coupon server 12. The coupon server is configured to receive coupon campaigns 48 from an advertiser client 50. The coupon campaigns specify the parameters (scheduling, coupon benefit, target redeemer candidate and promoter candidate profiles, etc.) for generating coupons and serving electronic coupons 18 to user client devices 14 and friend client devices 16 as described above.

The coupon server 12 may include a database 52 of user profiles 54 for each of a plurality of users. The user profiles 54 typically include social graph data 56 and historical data 58 for each user. The social graph data 56 may be derived from a social network or address book of the user, for example. A user's social graph may include links to friends, their friends links to other friends, and so on. The user's social graph may further include links to events and groups within the social network, a history of the users likes or fan preference indications within the social network, as well as the social network profile for the user. The historical data 58 may be browser history, application usage history, email/calendar/telephone usage history, location information derived from GPS data, cell phone tower data, Wi-Fi access point data, etc.

The computerized coupon server system 10 further includes predictive models 59 for predicting which users would be effective promoters and thus should be sent electronic coupons, and which friends of those users would be potential consumers of the target goods or services, and thus should be selected as redeemer candidates. The predictive models 59 include a promoter module 60 configured to identify from the user profiles 54 a subset of users who are promoter candidates 62 predicted within a threshold probability to become promoters of a target product or service, based on determined matches between the historical data 58 and social graph data 56 for each user and promoter matching criteria. The promoter module may be configured to use a first predictive model generated by a first machine learning algorithm to identify the promoter candidates 62, as described below. The promoter matching criteria may be, for example, a desired promoter criteria specified by an advertiser, such as Seattle resident, coffee drinker, or software engineer. As one example, the promoter module 60 may be configured to determine the promoter candidates 62 by examining the social graph 56 of the user to determine whether the user is a self-expressed fan of the target product or service, by examining purchase transactions in the historical data 58 to determine that the user has purchased the target product or service, and/or by examining browser history in the historical data 58 to determine if the user visits websites related to the target product or service.

The predictive models 59 further include a redeemer module 64 configured to, for each identified promoter candidate 62, determine one or more redeemer candidates 66 from among users that have a predetermined social relationship with each promoter candidate 62 and who are likely within a threshold probability to be redeem a coupon for the target product or service. The redeemer module 64 may be configured to use a second predictive model generated by a second machine learning algorithm to identify the redeemer candidates 66, as described below. The redeemer module 64 may be configured to determine the redeemer candidates 66 by examining the social graph 56 of each user to determine whether the user is a self-expressed fan of the target product or service, examining the social graph 56 of each user to determine whether the user is friends with fans of the target product or service, by examining purchase transactions in the historical data 58 to determine that the user has not yet purchased the target product or service, and/or by examining browser history in the historical data 58 to determine if the user visits websites related to category of products or services to which the target product or service belongs, as some examples.

It will be appreciated that machine learning techniques may be used to create and train the predictive models 59 in an adaptive manner over time. To that end, the promoter module 60 may implement machine learning algorithms 61 to create and train the predictive model used to select promoter candidates 62. Examples of machine learning techniques that; may be implemented by such machine learning algorithms include classification and regression tree analysis, Bayesian networks, and support vector machines, among others. These machine learning algorithms may be used to statistically analyze data such as user profiles 54, which contain social graph data 56 and historical data 58, and compute the expected value of offering a sharable electronic coupon to a promoter candidate for redemption by a set of redeemer candidates, based on user profile data 54 collected about the promoter candidate and the promoter candidates friends. This data may include whether the promoter candidate has explicitly provided positive feedback (e.g., indicated a “like” for in a social network, blogged positively about, etc.) regarding the target product or service that is the subject of the coupon campaign, or implicitly acted in a manner that is inferred to be an endorsement of the target product or service (e.g., frequently purchases the target product or service, etc.), and has friends that are influenced by the promoter candidate and thus may be inferred to be easily shepherded by the promoter candidate to use the product or service via the shared electronic coupon.

The redeemer module 64 may also be configured to implement machine learning algorithms 61 to produce the predictive model that is used to select redeemer candidates 66. These machine learning algorithms may be configured to, for each of a plurality of friends in a social graph of a promoter candidate 62, examine user profile data 54 including social graph data 56 and historical data 58, and based upon this user profile data 54 for each friend, compute an expected value of including that friend in a list of redeemer candidates in an electronic coupon offered to the promoter candidate. As part of this computation, the machine learning algorithms may be configured to predict, the probability that potential redeemer candidates have not before purchased the target product or service, or have purchased it less frequently than a threshold frequency or longer ago than a predetermined time period.

The machine learning algorithms can process prior data sets of promoter candidates who were provided with electronic coupons redeemable by friend redeemer candidates, and using redemption feedback indicating which coupons were redeemed by which redeemer candidates, can tune the predictive model to assign higher expected values to candidates that share attributes in common with past redeemer candidates who redeemed coupons.

In this manner machine learning procedures may be used to identify subsets of friends who are predicted to have a higher probability of using the electronic coupons. These friends may be added to lists of redeemer candidates within whom invitations for discounts or free services are to be made available, via the shared electronic coupons distributed to the promoter candidates. As one use case example, the decision to give a sharable electronic coupon to a user who is detected to (1) frequently eat at Restaurant A, which is known for its wine list, and (2) have many friends living nearby who are wine lovers and who have not yet eaten at Restaurant. A, might; be determined to have a high expected value, based on machine learning from other users who have been given sharable electronic coupons for group meals at restaurants with excellent wine lists and who have wine loving friends. The machine learning might show, for example, that such groups have a higher probability of redeeming the coupons, and a higher average purchase total due (presumably) to their purchase of premium wines, than groups of users who do not share an affinity for wine. These wine loving friends are selected programmatically by the predictive model, which is continuously optimizing itself based on measurements of redemption feedback.

As another use case example, the redeemer module 64 may be configured to select as potential redeemer candidates a category or shared attribute among a promoter candidate's friends, rather than particular friends of the promoter candidate. For example, the following categories of friends may be selected as redeemer candidates: “all” friends of the promoter candidate, those friends that share an attribute with the promoter candidate, such as having the same employer, those friends that share a common attribute, such having expressed a “like” for wine, friends over 55 years of age, friends who have shopped at X store, etc. in this manner, the promoter candidate may be presented with an electronic coupon that may be redeemed by any friend, any coworker, any vine aficionado friend, any friend over 55 years old, any friend who has been detected to shop at X store, etc.

Further, it will appreciated that in some examples, the friend may not be an explicit member of the promoter's social graph. As a non-limiting example, a promoter may receive a coupon redeemable by the promoter and a child, grandparent, or other real-world relative or acquaintance. The redeemer module in this case may determine a category or description of the redeemer candidate not based on an explicit social graph but based on generalized categories of redeemer candidates, and may leave selection of the particular person to be chosen as a redeemer up to the promoter.

Turning now to the mechanism by which electronic coupons 18 are generated, the computerized coupon server system 10 further includes a coupon engine 67 configured to generate and serve an electronic coupon 18 for a target product or service to a user client device 14 of a promoter candidate 62 for display on a display D associated with the user client device 14.

Each of the user client device 14 and the friend client device 16 includes a processor P, mass storage MS, and memory M, and global positioning satellite GPS receiver. Programs PR stored in mass storage are configured to be implemented by the processor P using portions of memory M, to achieve the various functionalities discussed herein. The GPS receiver determines the location of the device based on satellite signals and may periodically send the determined location of the device to the coupon server 12. Further, although not shown in FIG. 3, it will be appreciated that coupon server 12 is a hardware device that includes a processor, mass storage, and memory, which function in a similar manner to those of user client device 14, and friend client device 16.

Turning now to the process by which a user client device 14 interacts with the coupon server 12, initially a coupon request 68 is sent from the user client device to the coupon engine 58 of the coupon server 12. The coupon request may be initiated by a program PR executed by the user client device, such as a browser program or an application program, etc. In response to request 68, a user view 20a of the electronic coupon 18 is generated and served by the coupon engine to the requesting user client device 14. Example scenarios in which such a request might be made include a browser program viewing a social networking website that displays an electronic coupon 18 using content retrieved from the coupon server 12, and a coupon application program configured to contact the coupon server 12 to receive electronic coupons 18.

As described above, the electronic coupon includes a list of redeemer candidate friends. The redeemer candidate friends in the list are different from the promoter candidate, and are selected from a social graph of the promoter candidate. As discussed above, the electronic coupon is typically not redeemable by the promoter candidate alone, but is redeemable either by the redeemer candidate friend, alone or with the user or other friends, etc. In this manner, the user is prompted to select from among the list one or more redeemer candidate friends with which to share the electronic coupon. Upon making this selection, a friend selection message 70 is sent to the coupon engine, notifying the coupon engine of the selected redeemer candidate friend.

Once the friend selection message 70 is sent to the coupon engine, it will be appreciated that the coupon engine 67 may attempt to notify the redeemer candidate of the electronic coupon 18, for example, by sending the friend client device 14 an email message, text message, or other message, including a link to the electronic coupon 18. After sending this notification, the coupon engine waits a period of time until receiving a coupon request 72 from the friend client device 16. Once coupon request 72 is received, the coupon engine 67 of the coupon server 12 is configured to serve a friend view 20b of the electronic coupon to the friend client device 16.

When the friend view 20b of the electronic coupon 18 is displayed on the friend client device, the redeemer candidate may select a redemption selector, illustrated at 42 in FIG. 1, which causes a redemption message 74 to be sent to the coupon engine 67, and initiates the redemption process. The coupon engine 67 is configured to receive the redemption message 74 indicating that the coupon has been redeemed. Upon determining that the electronic coupon has been redeemed by the redemption candidate, the coupon engine is configured to credit the user's account 71 with award points and send an award points message 76 to the client device of the promoter who sent the coupon to the redeemer, indicating a value of award points awarded to the promoter for the redemption by the redeemer. In this manner both the user as promoter, and the friend as redeemer receive a benefit from the use of the electronic coupon.

Now, use various case scenarios for the system 10 will be described. As one example, the redeemer candidates and associated promoter candidates are detected to have an affinity for the same target product or service in a social network. The affinity may be determined by detecting that the user has indicated he is a “fan” of the target product or service, from indication a “like” for the target product or service, having many friends that have “liked” something, etc. Thus, electronic coupons for free coffee may be delivered to users who have “liked” a local coffee shop in city A, which are redeemable by friends of the user in the same city who have “liked” other coffee shops but not the advertiser's coffee shop.

In some embodiments, the electronic coupon may be generated upon detection of the promoter candidate and associated redeemer candidates in geographic proximity of a retail establishment at which the target product or service is offered. Thus, for example, the coupon system may receive a request for a coupon from a mobile device of a user, with GPS information indicating that the user is in the vicinity of a new restaurant that is celebrating a grand opening with a coupon promotion. The social graph of the user may contain 3 friends who are detected to also be in the vicinity of the restaurant, and who have expressed a preference for Italian food by becoming fans of a famous Italian chef in a social network. In this case the promoter candidate is served a coupon for the user and the 3 friends to dine together at the Italian restaurant. The user forwards the coupon the three friends and asks them in a message field if they would like to join him for dinner this week.

In another example, an electronic coupon may be generated for a promoter candidate and redeemer candidate to redeem together, in situations where two users are detected to spend time together in the same physical location. This detection may be performed by an analysis of the historical data at the coupon server, to detect trends in location data received from the GPS units on each of the users and friends client device, from calendar data, event participation records, email searching, purchase transactions, travel records, etc. In this manner, electronic coupons for co-participating users and friends are only presented to users and friends that actually have been inferred to spend time together in the same physical location. Thus, for example, a user and his friends who spend all day in the same office building laboring away may be offered an urban miniature golf coupon, for a noon-hour session of miniature golf at a deep discount. The coupon may specify that two other friends and the user can redeem the coupon together, so that all can play a round of miniature golf together.

In another example, the electronic coupons may be for online events that users and friends may participate in by logging in through a client device. One example of such an event is a multiplayer online game. For these coupons for online events, the coupon server may select; promoter candidates and redeemer candidates from among users who are detected to participate in such group oriented online events, based on historical data, such as browser history for browser based games.

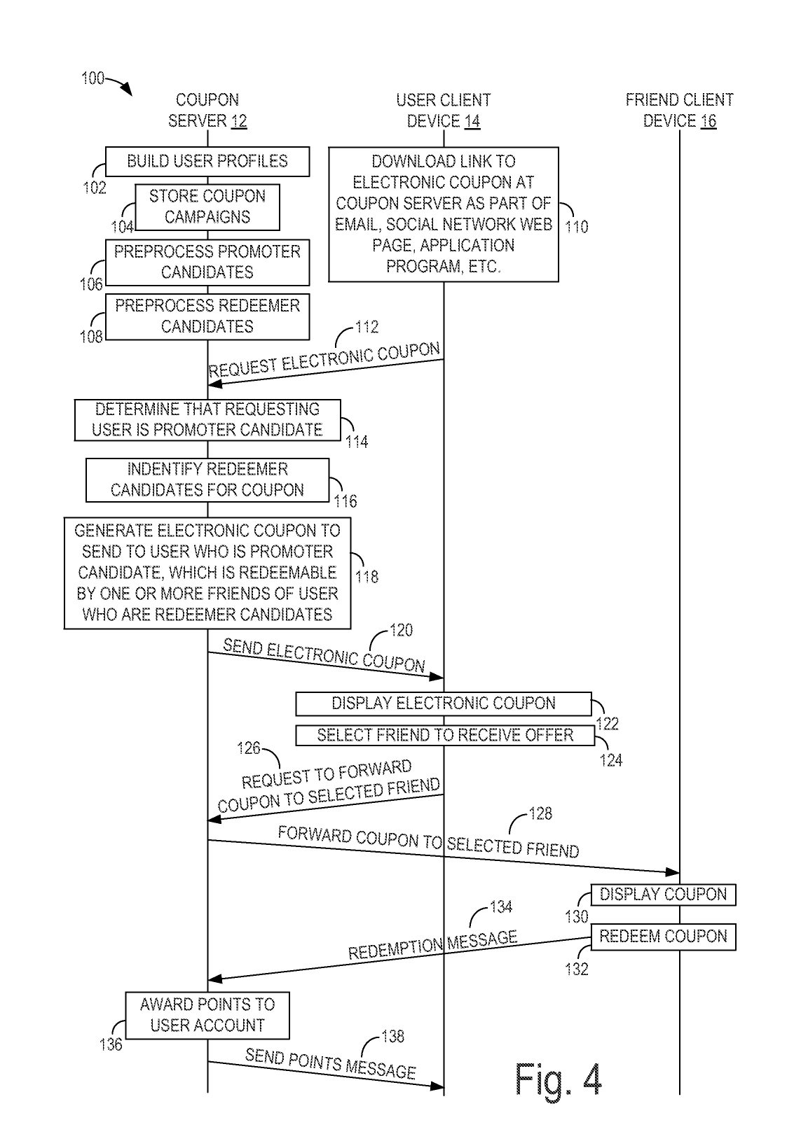

Turning now to FIG. 4, a method for distributing an electronic coupon is illustrated generally at 100. Beginning initially with steps performed on the coupon server 12, method 100 includes at 102 building user profiles accessible to a coupon server. The user profiles typically include social graph data and historical data for users who have registered with the coupon server, as described above. The user profiles are typically built after receiving consent from the users to participate in the electronic coupon program, and after informing the users of user data being monitored in order to aid in selection of users as promoter and redeemer candidates.

At 104, the method includes storing coupon campaigns received from advertisers. The coupon campaigns specify the parameters by which the coupon server 12 will identify who is to receive a coupon as a promoter and who will be eligible to redeem the coupon as a redeemer, and will also specify the terms of the coupon such as the coupon benefit, co-participation terms, expiration, and transferability, as discussed above.

At 106, the method includes preprocessing promoter candidates who are eligible to receive electronic coupons offered by the coupon server. This is typically accomplished by identifying from user profiles stored in a user profile database a subset of users who are promoter candidates predicted within a threshold probability to become promoters of a target product or service, based on determined matches between historical data and social graph data for each user and promoter matching criteria.

At 108, the method includes preprocessing redeemer candidates who are eligible to redeem electronic coupons offered by the coupon server. This is typically accomplished by, for each identified promoter, determining one or more redeemer candidates from among users that have a predetermined social relationship with each promoter are likely within a threshold probability to redeem a coupon for the target product or service.

Turning now to steps performed on the user client device 14, it will be appreciated that a user of user client device 14 may use a browser program to browse websites, such as a social network website, or an application program to access web based services, such as a map service, email service, text messaging, etc. in the context of such use, at 110, the method may include downloading from a server serving a website, or hosting an email service, a map service, or other service, a link to an electronic coupon served by the coupon server 12. As a result of the link, a request is sent from the user client device 14 to the coupon server for the electronic coupon.

Returning to steps performed at coupon server 12, the method at 112 includes receiving the request for the electronic coupon, at the coupon server. At 114, the method typically includes determining that the requesting user is a promoter candidate for an electronic coupon for a target product or service, based on a user profile. At 116, the method includes identifying one or more redeemer candidates for the electronic coupon for the target product or service from among friends of the user in a social graph of the user.

At 118, the method includes generating the electronic coupon to be redeemable by the one or more redeemer candidates or by the one or more redeemer candidates and the user, but not by the user alone. The electronic coupon includes a description of a coupon benefit, and a list of the one or more redeemer candidates. The list is typically selectable by the user to cause the coupon to be sent to a friend client device of the selected redeemer candidate. At 120 upon such selection, the electronic coupon is sent to the requesting user client device 14.

At the user client device, at 122 the electronic coupon is displayed on a display associated with the user client device 14. It will be appreciated that typically a user view of the electronic coupon is displayed, similar to that illustrated at 20a in FIG. 1. Further, at 124, the user of the user client device selects a friend from among the redeemer candidates, who is to receive the coupon. This generates a request to forward the electronic coupon to a selected redeemer candidate friend, which is sent to the coupon server 12.

Returning to steps performed on the coupon server, at 126, the method includes receiving at the coupon server a request from the user client device to forward the coupon to the selected redeemer candidate friend, via user selection of a redeemer candidate in the list. At 128, in response to receiving the request, the method includes forwarding the coupon is to a friend client device 16 of the selected redeemer candidate.

Turning now to steps performed by the friend client device 16, at 130, the electronic coupon is displayed on a display associated with the friend client device 16. It will be appreciated that typically a friend view of the electronic coupon is displayed, similar to the friend view 20b in FIG. 1. At 132, the coupon may be redeemed by the friend, for example, by selection of a redemption selector included in the friend view of the electronic coupon, as discussed above.

At the coupon server, at 134 the method may further include receiving a message from the friend client device indicating that the coupon has been redeemed by the redeemer candidate. At 136, the method may include awarding an account of the user award points for the redemption. At 138, the method may include sending an award points message from the coupon server to the user client device, to inform the user that the award points have been awarded.

The above described systems and methods may be used to efficiently distribute electronic coupons to users, and friends of users, of a coupon server system, in a manner that benefits users, friends, and advertisers. Since the promoter candidates and redeemer candidates are selected based on user profile data, the relevance of the coupons to their recipients is promoted, helping avoid coupon fatigue associated with prior coupons. Relevant ads capture their audience's attention to a greater degree, thereby benefiting the advertiser. Further, the use of award points encourages the user's to make high quality selections of friends when forwarding electronic coupons to others, thereby benefiting the user with an increased probability of earning award points.

Regarding the software and hardware operating environments described herein, it will be appreciated that the terms “module,” “program,” and “engine” have been used to describe software components that are implemented by processors of the various computing hardware devices described herein, to perform one or more particular functions. The terms “module,” “program,” and “engine” are meant to encompass individual or groups of executable files, data files, libraries, drivers, scripts, database records, etc. Further, it will be understood that the coupon server, while illustrated as a single server for ease of discussion purposes, may be implemented as a group of coordinated servers, which may be co-located or distributed across a computer network, as will be appreciated by those familiar with cloud computing environments.

It will be understood that user client devices may be person computers, laptop devices, notebook devices, personal data assistants, tablet computers, smart phones, or various other computing devices. Further, the processor and volatile memory may be integrated in a common integrated circuitry, as a so-called system on a chip in some embodiments, and the mass storage may be a variety of non-volatile storage devices, such as a hard drive, firmware, read only memory (ROM), electronically erasable programmable (EEPROM), programmable read only computer memory chips that can be erased FLASH memory, optical drive, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An electronic coupon comprising, in a user view displayed on a user client device:
a benefit display region displaying a textual and/or graphical representation of a coupon benefit; and
a candidate display region displaying a list of one or more redeemer candidate friends for the electronic coupon, the redeemer candidate friends being selected from among friends in a social network profile or address book of the user, wherein each redeemer candidate friend in the list has an associated selector, and wherein selection by the user of a selector corresponding to a redeemer candidate friend causes the user client device to send a message to a coupon server to instruct the coupon server to send the electronic coupon to a client device of the selected redeemer candidate friend.

2. The electronic coupon of claim 1, further comprising:
a conditions display region including one or more conditions of the coupon benefit.

3. The electronic coupon of claim 2, wherein one of the conditions specifies that the benefit is redeemable by the friend, or by the user and the friend together, but not by the user.

4. The electronic coupon of claim 2, wherein one of the conditions specifies whether the coupon is transferable to friends of friends in the social network.

5. The electronic coupon of claim 1, further comprising, an award points display region including a display of award points earned by the user through sharing electronic coupons with friends who redeem those coupons.

6. The electronic coupon of claim 1, further comprising, in a friend view displayed on the client device of the selected redeemer candidate:
an identity of the user from which the selected redeemer candidate received the coupon;
a message from the user; and
a redemption selector, which upon actuation is configured to initiate redemption of the electronic coupon.

7. A computerized coupon server system, comprising, at least one server device configured to implement:
a database of user profiles for each of a plurality of users, the user profiles including social graph data and historical data for each user;
a promoter module configured to use a first predictive model generated by a first machine learning algorithm to identify from the user profiles a subset of users who are promoter candidates predicted within a threshold probability to become promoters of a target product or service, based on determined matches between the historical data and social graph data for each user and promoter matching criteria;
a redeemer module configured to use a second predictive model generated by a second machine learning algorithm to, for each identified promoter, determine one or more redeemer candidates from among users that have a predetermined social relationship with each promoter are likely within a threshold probability to be redeem a coupon for the target product or service;
an coupon engine configured to generate and serve an electronic coupon for a target product or service to a client device of each of the promoter candidates for display on a display associated with the client device, wherein each electronic coupon for each promoter candidate includes one or more redeemer candidates who are different from the promoter candidate and who are selected from a social graph of the promoter candidate.

8. The coupon server system of claim 7, wherein the electronic coupon is not redeemable by the promoter candidate alone.

9. The coupon server system of claim 8, wherein the promoter module is configured to determine the promoter candidates by examining the social graph of each user to determine whether the user is a self-expressed fan of the target product or service, by examining purchase transactions in the historical data to determine that the user has purchased the target product or service, and/or by examining browser history in the historical data to determine if the user visits websites related to the target product or service.

10. The coupon server system of claim 8, wherein the redeemer module is configured to determine the redeemer candidates by examining the social graph of each user to determine whether the user is a self-expressed fan of the target product or service, examining the social graph of each user to determine whether the user is friends with fans of the target product or service, by examining purchase transactions in the historical data to determine that the user has not yet purchased the target product or service, and/or by examining browser history in the historical data to determine if the user visits websites related to category of products or services to which the target product or service belongs.

11. The coupon server system of claim 8, wherein the redeemer candidates and associated promoter candidates are detected to have an affinity for the same target product or service in a social network.

12. The coupon server system of claim 11, wherein the affinity is determined by detecting that the user is a fan of the target product or service, has expressed an indication of a like for the target product or service, or has many friends that have liked a target product or service, within a social network.

13. The coupon server system of claim 8, wherein the electronic coupon is generated upon detection of the promoter candidate and associated redeemer candidates and in geographic proximity of a retail establishment at which the target product or service is offered.

14. The system of claim 8, wherein the coupon engine is configured to receive a message indicating that the coupon has been redeemed, and send an award points message to the client device of the promoter who sent the coupon to the redeemer, indicating a value of award points awarded to the promoter for the redemption by the redeemer.

15. A method for distributing an electronic coupon, comprising, at a coupon server:
determining that a user is a promoter candidate for an electronic coupon for a target product or service, based on a user profile;
identifying one or more redeemer candidates for the electronic coupon for the target product or service from among friends of the user in a social graph of the user;
generating the electronic coupon to be redeemable by the one or more redeemer candidates or by the one or more redeemer candidates and the user, but not by the user alone, the electronic coupon including a description of a coupon benefit, and a list of the one or more redeemer candidates friends of the user, the list being selectable by the user to cause the coupon to be sent to a friend client device of the selected redeemer candidate; and
sending the electronic coupon to the user client device.

16. The method for distributing an electronic coupon of claim 15, further comprising:
receiving a request from the user client device to forward the coupon to the selected redeemer candidate, via user selection of a redeemer candidate in the list; and
in response to receiving the request, forwarding the coupon to the friend client device of the selected redeemer candidate.

17. The method for distributing an electronic coupon of claim 16, further comprising:
receiving a message from the friend client device indicating that the coupon has been redeemed by the redeemer candidate.

18. The method for distributing an electronic coupon of claim 15, further comprising:
awarding an account of the user award points for the redemption by the redeemer candidate.

19. The method for distributing an electronic coupon of claim 15, further comprising:
determining from user profiles stored in a user profile database a subset of users who are promoter candidates predicted within a threshold probability to become promoters of a target product or service, based on determined matches between historical data and social graph data for each user and promoter matching criteria.

20. The method for distributing an electronic coupon of claim 19, further comprising:
for each identified promoter, determining one or more redeemer candidates from among users that have a predetermined social relationship with each promoter are likely within a threshold probability to be redeem a coupon for the target product or service.
